(19) United States
(12) Patent Application Publication
(10) Pub. No.: US 2003/0133434 A1
(43) Pub. Date: Jul. 17, 2003

(54) Methods, apparatus and computer program products for configuring a network interface of a wireless mobile data base station

(76) Inventors: Mikael Johansson, Morrisville, NC (US); Elena Casanova, Raleigh, NC (US); Anders Gothe, Morrisville, NC (US)

Correspondence Address: MYERS BIGEL SIBLEY & SAJOVEC, PO BOX 37428, RALEIGH, NC, 27627, US

(21) Appl. No.: 10/047,859

(22) Filed: Jan. 15, 2002

(51) Int. Cl. H04J 3/24; H04L 12/28

(52) U.S. Cl. 370/349; 370/392

(57) ABSTRACT

A wireless base station of a wireless mobile data communications system, such as a Mobile Data Base Station (MDBS) of a Cellular Digital Packet Data (CDPD) system, is configured. A port number and/or an internet address to be assigned to the wireless base station is determined. A datagram including the assigned port number and/or internet address is transmitted from a controller of the wireless mobile data communications system to the wireless base station via a backbone network of the wireless mobile data communications system. Responsive to receipt of the datagram at the wireless base station, the wireless base station is configured to accept datagrams addressed to the assigned port number and/or internet address. Related apparatus and computer program products are also described.

### BACKGROUND OF THE INVENTION

The present invention relates to wireless communications systems and methods, and more particularly, to wireless mobile data communications systems, methods and computer program products.

Wireless communications technologies are widely used to provide communications services. For example, cellular mobile telephone systems are used throughout the world to provide telephone voice services. Wireless communications services are also widely used to provide text and other messaging services, such as paging services.

A growing market for the application of wireless communications technologies is the provision of data communications services. For example, wireless mobile data communications systems are now used to provide wireless wide area networking such that mobile users, such as salespeople, maintenance personnel, and the like, may use networked applications. Wireless mobile data communications systems may also be used to provide mobile internet services.

A conventional Cellular Digital Packet Data (CDPD) communications system 110 is illustrated in FIG. 1. The CDPD system 110 includes multiple Mobile Data Intermediate Systems (MD-IS) 111 and a Network Management System (NMS) 112 that are linked by a CDPD backbone network 113. The MD-IS's 111 control communications with respective groups of Mobile Data Base Stations (MDBSs) 116, which are shown as coupled to the CDPD backbone network by a router 114 and datagram relay network 115. The MD-IS's 111, the MDBS's 116 and associated network hardware provide means for Mobile End Stations (M-ESs) 120 to communicate data with one another and/or with an external network (e.g., an internet) 130. Commonly, the MDBSs 116 communicate with the MD-ISs 111 and the NMS 112 using a transport layer/network layer stack such as TCP/IP (Transport Control Protocol over Internet Protocol), UDP/IP (User Datagram Protocol over Internet Protocol) or TP4/CNLP (Transport Protocol 4 over Connectionless Network Protocol). A detailed discussion of CDPD may be found in “Cellular Digital Packet Data Networks,” by Budka et al., Bell Labs Technical Journal, Summer 1997, pp. 164-181. Other wireless mobile data communications systems include General Packet Radio System, which provides packet data communications for Global System for Mobile Communications (GSM) and other Time-Division Multiple Access (TDMA) systems, as well as CDMA (Code Division Multiple Access and UMTS (Universal Mobile Telecommunications System).

Wireless mobile data communications systems commonly use existing wireless voice communications infrastructure. For example, CDPD services may be provided by fitting existing Advanced Mobile Phone System (AMPS) base stations with supplemental hardware that enables these base stations to serve as MDBSs in the CDPD network. It is generally desirable that the installation and maintenance of such MDBSs be efficient and cost effective.

### SUMMARY OF THE INVENTION

According to embodiments of the present invention, a wireless base station of a wireless mobile data communications system, such as a Mobile Data Base Station (MDBS) of a Cellular Digital Packet Data (CDPD) system, is configured. A port number and/or an internet address to be assigned to the wireless base station is determined. A datagram including the assigned port number and/or internet address is transmitted from a controller of the wireless mobile data communications system to the wireless base station via a backbone network of the wireless mobile data communications system. Responsive to receipt of the datagram at the wireless base station, the wireless base station is configured to accept datagrams addressed to the assigned port number and/or internet address. The present invention may be embodied as methods, apparatus and computer program products.

### BRIEF DESCRIPTION OF THE DRAWINGS

FIG. 1 is a schematic diagram illustrating a CDPD communications system according to the prior art.

FIG. 2 is a schematic diagram illustrating a wireless base station according to some embodiments of the present invention.

FIG. 3 is a schematic diagram illustrating a wireless base station according to other embodiments of the present invention.

FIGS. 4 and 5 are flowcharts illustrating exemplary base station configuration operations according to various embodiments of the present invention.

### DETAILED DESCRIPTION

The present invention will now be described more fully with reference to the accompanying drawings, in which typical embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The exemplary embodiments described herein specifically relate to “plug and play” configuration of a Mobile Data Base Station (MDBS) of a Cellular Digital Packet Data (CDPD) communications system. It will be appreciated, however, that the present invention is also applicable to other wireless data communications systems, such as General Packet Radio Systems (GPRS).

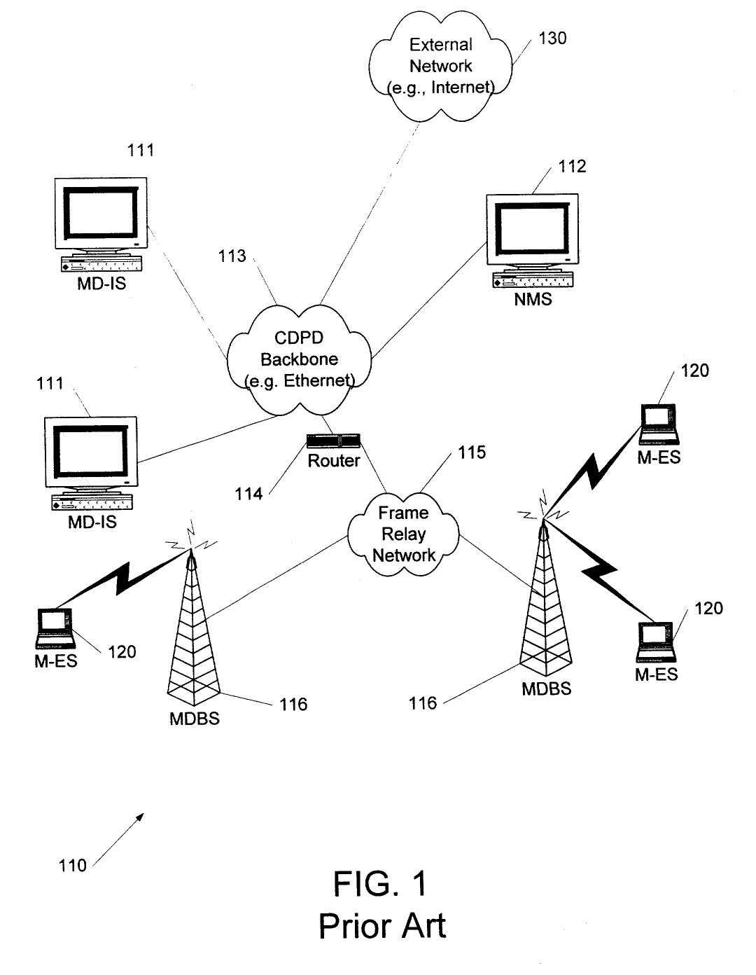

In the present application, FIGS. 1-5 are schematic diagrams and flowcharts illustrating exemplary communications apparatus and operations according to embodiments of the present invention. It will be understood that blocks of the schematic diagrams and flowcharts, and combinations of blocks therein, may be implemented using one or more electronic circuits, such as circuits included in a wireless terminal or in a wireless communications system, for example, in a wireless mobile data base station or other component of a wireless mobile data communications system. It will also be appreciated that, in general, blocks of the schematic diagrams and flowcharts, and combinations of blocks therein, may be implemented in one or more electronic circuits, such as in one or more discrete electronic components, one or more integrated circuits (ICs) and/or one or more application specific integrated circuits (ASICs), as well as by computer program instructions which may be executed by a computer or other data processing apparatus, such as a microprocessor or digital signal processor (DSP), to produce a machine such that the instructions which execute on the computer or other programmable data processing apparatus create electronic circuits or other means that implement the operations specified in the block or blocks. The computer program instructions may also be executed on a computer or other data processing apparatus to cause a series of operations to be performed on the computer or other programmable apparatus to produce a computer implemented process such that the instructions which execute on the computer or other programmable apparatus provide operations for implementing the operation specified in the block or blocks.

The computer program instructions may also be embodied in the form of a computer program product in a computer-readable storage medium, i.e., as computer-readable program code embodied in the medium for use by or in connection with an instruction execution system. The computer-readable storage medium may include, but is not limited to, electronic, magnetic, optical or other storage media, such as a magnetic or optical disk or an integrated circuit memory device. For example, the computer program instructions may be embodied in memory included in a wireless terminal or a wireless communications system and/or in an apparatus and/or storage medium operable to program such memory. Accordingly, blocks of the schematic diagrams and flowcharts of FIGS. 1-5 support electronic circuits and other means that perform the specified operations, acts for performing the specified operations, and computer program products configured to perform the specified operations.

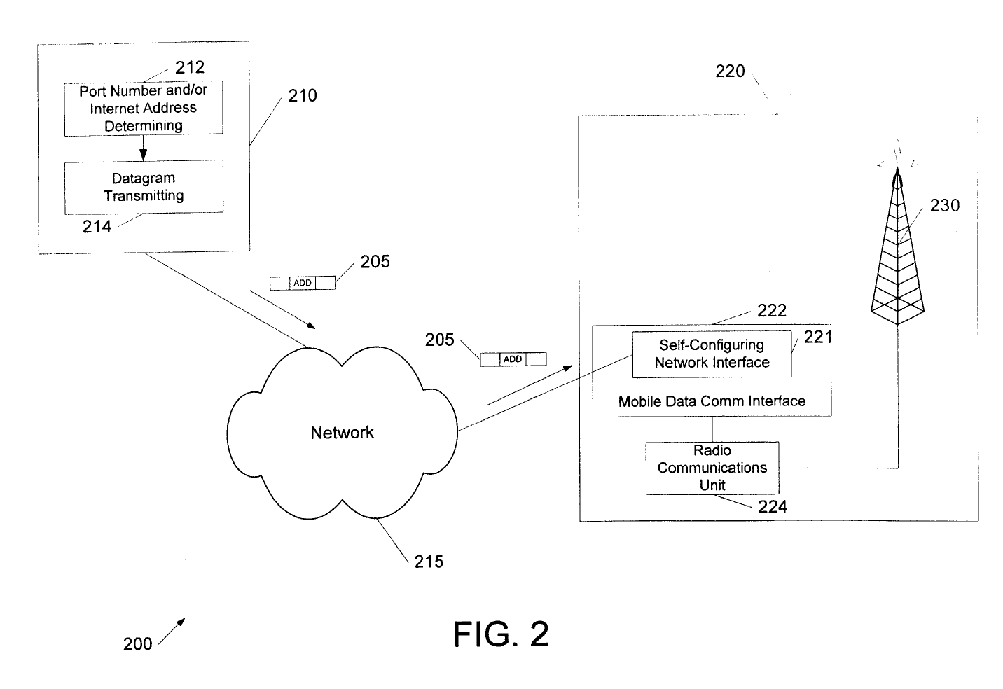

FIG. 2 illustrates a wireless mobile data communications system according to embodiments of the present invention, in particular, a Cellular Digital Packet Data (CDPD) system 200. The system 200 includes a Mobile Data Base Station (MDBS) 220 that is linked to a controller 210 by an intervening network 215. As shown, the MDBS 220 includes a radio communications unit 224 that supports radio communications interface with terminals, e.g., cellular telephones and CDPD Mobile End Stations (M-ESs), via a base station antenna 230. The MDBS 220 further includes a mobile data communications interface 222 that provides communications between the radio communications unit 224 and the network 215. In particular, the network 215 is operative to send and receive datagrams to and from the MDBS 220, which datagrams may conform, for example, to a network protocol, such as Internet Protocol (IP) or Connectionless Protocol (CNLP), and/or a transport protocol, such as Transport Control Protocol (TCP/IP), User Datagram Protocol (UDP) or Transport Protocol 4 (TP4).

As shown, the controller 210 includes means 212 for determining a port number and/or internet address for the MDBS 220, and means 214, responsive to the means 212 for determining the port number and/or internet address, for transmitting a datagram 205 including the determined port number and/or internet address. The mobile data communications interface 222 includes a self-configuring network interface 221 that is operative, responsive to receipt of the datagram sent 205 from the controller 210 via the network 215, to configure itself to use the port number (e.g., for transport layer datagrams) and/or the internet address (e.g., for network layer datagrams) in the received datagram 205 as its port number and/or internet address.

It will be appreciated that the controller 210 may comprise any of a variety of different components commonly used in a wireless mobile data communications system. For example, in CDPD embodiments, the controller 210 may comprise a Network Management System (NMS) node configured to perform the port number/internet address determination and datagram transmission functions described above. The controller 210 may include, for example, a computer or other data processing device upon which computer program code may be executed to provide the port number/internet address determining means 212 and the transmitting means 214. It will be appreciated that, in general, the controller 210 may be implemented using hardware, software (or firmware), and combinations thereof. The present invention may also be embodied as computer program code embodied in a storage medium configured such that computer program code executed on such a computer or data processing device provides the functions of the controller 210, including the port number/internet address determining means 212 and the transmitting means 214. It will also be understood that components of the controller 210 may be positioned at a common location, or may be distributed over multiple locations, for example, over multiple nodes of a network.

It will be further appreciated that the radio communications unit 224, the mobile data communications interface 222 and the self-configuring network interface 221 of the MDBS 220 may, in general, be implemented using any of a variety of hardware, software (or firmware), and combinations thereof. For example, the radio communications unit 224 may include analog and/or digital signal processing components such as mixers, modulators, demodulators, amplifiers, filters and associated control circuitry. The mobile data communications interface 222 and the self-configuring network interface 221 may, for example, be implemented as one or more program code modules that implement protocol layers and other control structures using a general or special purpose data processing circuit, such as a microprocessor. It will be further appreciated that, although the radio communications unit 224, the mobile data communications interface 222 and the self-configuring network interface 221 are illustrated in FIG. 2 as being co-located, these components may be distributed over multiple locations. The present invention may also be embodied as computer program code embodied in a storage medium configured such that computer program code executed on a computer or data processing device provides the functions of the self-configuring network interface 221 of the mobile data communications interface 222.

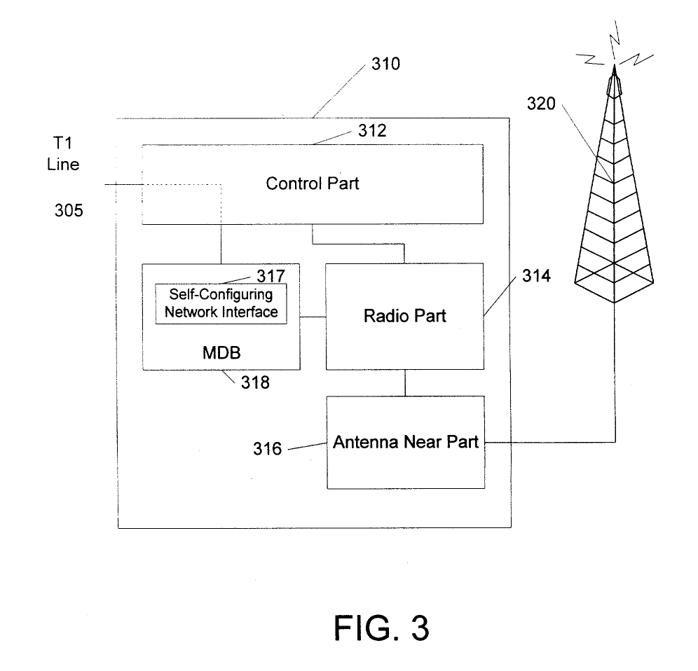

FIG. 3 illustrates a wireless base station 300 according to some embodiments of the present invention. As shown, the wireless base station 300 includes circuitry 310 that includes a control part 312 that sends and receives signals via a communications line, for example, a T1 telephone line 305. The control part 312 controls operations of a radio part 314, to provide radio communications with mobile terminals via an antenna near part 316 and an antenna part 320. To provide an MDBS functionality, the circuitry 310 further includes a Mobile Data Board (MDB) 318 that provide a data communications interface between the T1 line 305 and the radio part. As shown, the MDB 318 includes a self-configuring network interface circuit 317 that provides network communications between the base station 310 and a backbone network of a wireless mobile data communications system, and that is operative to configure itself to use a port number and/or internet address included in a datagram received from the network.

In a wireless mobile data communications base station, such as the base stations 200, 300 of FIGS. 2 and 3, a dedicated communications link is often used between a packet data network node, e.g., a frame relay node, and the base station. The present invention arises from the realization that, if such a dedicated connection between the node and the base station is provided, datagrams transmitted to the base station on the link between the packet data network and the base station can be limited to those datagrams intended for the base station. Accordingly, it is possible to achieve “plug and play” configuration of the base station by using port number and/or internet address information included in datagrams transmitted by the connecting node. Considering the time and expense that may be involved in manually configuring geographically dispersed base stations, such plug and play capability can provide significant cost savings to a system operator and/or an equipment vendor by reducing configuration errors and associated site visits, and by reducing installation time.

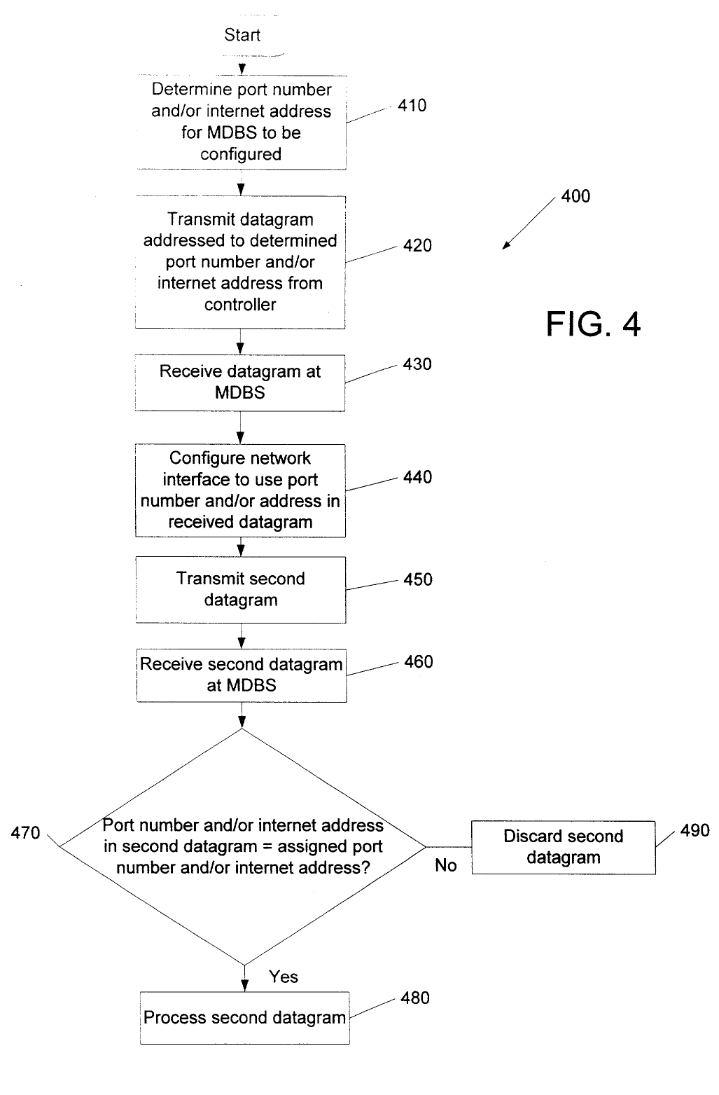

FIG. 4 illustrates exemplary operations 400 using such a plug and play configuration procedure for a base station, such as the CDPD MDBS 300 of FIG. 3, according to embodiments of the present invention. A port number and/or internet address for an MDBS to be configured is determined (Block 410). For example, in some embodiments of the present invention, an administrator at a controller of the CDPD system, e.g., at a user interface of a Network Management System (NMS) node, may select a port number and/or internet address that she knows is associated with a particular router or other network device that serves the MDBS. In other embodiments, the controller may automatically determine the desired port number and/or internet address in response to an indication that a MDBS is to be configured at a particular network location.

A datagram addressed to the determined port number and/or internet address is then transmitted from the controller (Block 420). The datagram is received at the MDBS (Block 430), for example, after routing through a backbone network of the CDPD network to a router connected to the MDBS. Responsive to receipt of the configuring datagram, the network interface of the MDBS configures itself to treat the destination port number and/or internet address of the received datagram as its port number and/or internet address (Block 440). For example, in preparation for configuration, the MDBS may be placed in a configuration mode, in which it first awaits an incoming message to examine a port number and/or internet address in a message yet to be sent. When a datagram finally is received, the MDBS may then configure a software process implementing a transport/network protocol stack based on the destination port number and/or internet address of the received datagram.

Upon transmission and receipt of a subsequent second datagram (Blocks 450, 460), for example, a datagram from an MD-IS or other CDPD node, the MDBS examines the received second datagram to see if it includes the previously assigned port number and/or internet address (Block 470). Consistent with conventional network operations, if the second datagram includes the assigned port number and/or internet address, the MDBS processes the datagram to recover information therein (Block 480). For example, the MDBS may pass the datagram to a process implementing another protocol(s), such as a process implementing a MDLP (Mobile Data Link Protocol) used in CDPD. If the second datagram does not include the proper port number and/or internet address, the MDBS may discard or otherwise disregard the second datagram (Block 490).

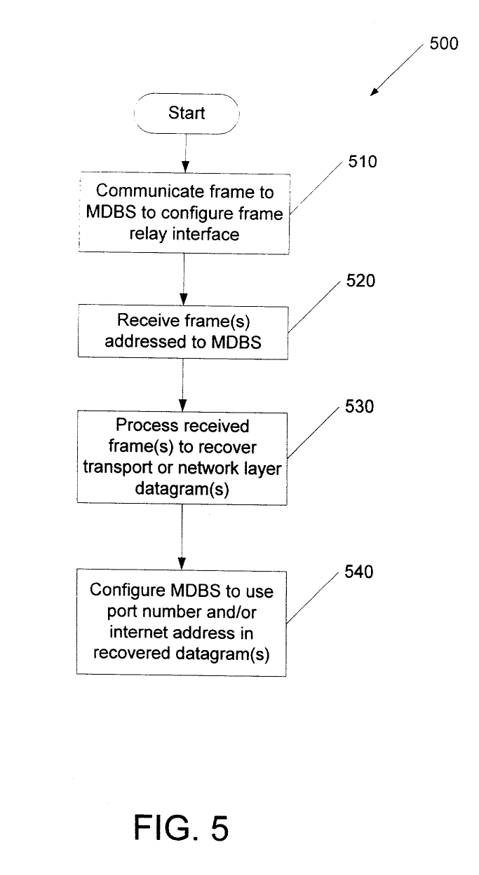

In some embodiments of the invention, the above-described configuration operations may be combined with a plug and play configuration procedure for a lower level protocol, for example, a frame relay protocol, as described in U.S. patent application Ser. No. ______ to Johansson et al., entitled “SELF-CONFIGURING WIRELESS MOBILE DATA BASE STATIONS AND CONFIGURATION OPERATIONS AND COMPUTER PROGRAM PRODUCTS FOR SAME”, which is filed concurrently herewith and incorporated herein by reference in its entirety. FIG. 5 illustrates exemplary operations 500 according to such embodiments of the present invention. A frame is communicated to a MDBS from a frame relay node to configure the MDBS to use a Data Link Connection Identifier (DLCI) in the received frame (Block 510), as described in the aforementioned Johannson et al. application. One or more additional frames are then received at the MDBS (Block 520). Responsive to receipt of the one or more frames, the received one or more frames are processed to recover one or more higher level datagrams, for example, one or more UDP or IP datagrams (Block 530). The MDBS is then configured to use the destination port number and/or internet address of the recovered one or more datagrams as its port number and/or internet address (Block 540).

In the drawings and specification, there have been disclosed typical embodiments of the invention and, although specific terms are employed, they are used in a generic and descriptive sense only and not for purposes of limitation, the scope of the invention being set forth in the following claims.

That which is claimed:

1. A method of configuring a wireless base station of a wireless mobile data communications system, the method comprising:
determining a port number and/or an internet address to be assigned to the wireless base station;
communicating a datagram including the assigned port number and/or internet address from a controller of the wireless mobile data communications system to the wireless base station via a backbone network of the wireless mobile data communications system; and
responsive to receipt of the datagram at the wireless base station, configuring the wireless base station to accept datagrams addressed to the assigned port number and/or internet address.

2. A method according to claim 1, wherein communicating a datagram including the assigned port number and/or internet address from a controller of the wireless mobile data communications system to the wireless base station via a backbone network of the wireless mobile data communications system comprises communicating a datagram including the assigned port number and/or internet address in a destination field of a header of the datagram.

3. A method according to claim 1, wherein communicating a datagram including the assigned port number and/or internet address from a controller of the wireless mobile data communications system to the wireless base station via a backbone network of the wireless mobile data communications system comprises:
communicating the datagram including the assigned port number and/or internet address to a router of the backbone network;
routing the received datagram to an interface between the router and the wireless base station.

4. A method according to claim 3, wherein communicating a datagram including the assigned port number and/or internet address from a controller of the wireless mobile data communications system to the wireless base station via a backbone network of the wireless mobile data communications system further comprises communicating the routed datagram to the wireless base station via a frame relay connection between the wireless base station and the router.

5. A method according to claim 3, wherein communicating a datagram including the assigned port number and/or internet address from a controller of the wireless mobile data communications system to the wireless base station via a backbone network of the wireless mobile data communications system comprises communicating the datagram according to one of TCP, UDP, or TP4.

6. A method according to claim 3, wherein communicating a datagram including the assigned port number and/or internet address from a controller of the wireless mobile data communications system to the wireless base station via a backbone network of the wireless mobile data communications system comprises communicating the datagram according to one of IP or CNLP.

7. A method according to claim 1, wherein the wireless mobile data communications system comprises a Cellular Digital Packet Data (CDPD) system, and wherein the wireless base station comprises a Mobile Data Base Station (MDBS).

8. A wireless base station for use in a wireless mobile data communications system, the wireless base station comprising:
a radio communications unit operative to communicate radio signals to and from mobile terminals; and
a mobile data communications interface coupled to the radio communications circuit and configured to connect to a node of a backbone network of the wireless mobile data communications system, the mobile data communications interface including a self-configuring network interface operative, responsive to receipt of a datagram from node of the backbone network including an assigned port number and/or a network address, to configure itself to accept datagrams addressed to the assigned port number and/or internet address over the backbone network.

9. A wireless base station according to claim 8, wherein the self-configuring network interface is operative, responsive to receipt of a datagram from the node of the backbone network including a port number and/or network address in a destination field thereof, to configure itself to accept datagrams addressed to the included port number and/or internet address.

10. A wireless base station according to claim 8, wherein self-configuring network interface is operative to receive the datagram including a port number and/or network address therein over a frame relay connection between the wireless base station and a router of the backbone network of the wireless mobile data communications system.

11. A wireless base station according to claim 8, wherein the assigned port number and/or internet address comprises one of a TCP port number, a UDP port number, a TP4 port number, an IP address or a CNLP address.

12. A wireless base station according to claim 8, wherein the wireless mobile data communications system comprises a Cellular Digital Packet Data (CDPD) system, and wherein the wireless base station comprises a Mobile Data Base Station (MDBS).

13. A controller for a wireless mobile data communications system, the controller comprising:
means for determining a port number and/or an internet address assigned to a wireless base station of the wireless mobile data communications system; and
means for transmitting a datagram including the assigned port number and/or internet address to the wireless base station via a backbone network of the wireless mobile data communications system.

14. A controller according to claim 13, wherein the means for transmitting a datagram including a port number and/or internet address for assignment to the wireless base station via a backbone network of the wireless mobile data communications system comprises means for transmitting a datagram including the assigned port number and/or internet address in a destination field of a header of the datagram.

15. A controller according to claim 13, wherein the means for transmitting a datagram including a port number and/or internet address for assignment to the wireless base station via a backbone network of the wireless mobile data communications system comprises means for transmitting the datagram including the assigned port number and/or internet address to a router of the backbone network.

16. A controller according to claim 13, wherein the assigned port number and/or internet address comprises one of a TCP port number, a UDP port number, a TP4 port number, an IP address or a CNLP address.

17. A controller according to claim 13, wherein the means for selecting and the means for transmitting comprise a Network Management System (NMS) node of a Cellular Digital Packet Data (CDPD) system.

18. A wireless base station, comprising:
means for receiving a datagram including an assigned port number and/or internet address for the wireless base station; and
means for configuring the wireless base station to accept datagrams addressed to the assigned port number and/or internet address in the received datagram.

19. A wireless base station according to claim 18, wherein the wireless base station comprises a Mobile Data Base Station (MDBS) of a Cellular Digital Packet Data (CDPD) system.

20. A computer program product for configuring a wireless base station of a wireless mobile data communications system, the computer program product comprising program code embodied in a computer-readable storage medium, the computer program code comprising:
program code for selecting a port number and/or an internet address for assignment to a wireless base station (wireless base station) of the wireless mobile data communications system; and
program code for transmitting a datagram including the assigned port number and/or internet address to the wireless base station via a backbone network of the wireless mobile data communications system.

21. A computer program product according to claim 20, wherein the program code for transmitting a datagram including a port number and/or internet address for assignment to the wireless base station via a backbone network of the wireless mobile data communications system comprises program code for transmitting a datagram including the assigned port number and/or internet address in a destination field of a header of the datagram.

22. A computer program product according to claim 20, wherein the program code for transmitting a datagram including a port number and/or internet address for assignment to the wireless base station via a backbone network of the wireless mobile data communications system comprises program code for transmitting the datagram including the assigned port number and/or internet address to a router of the backbone network.

23. A computer program product according to claim 20, wherein the assigned port number and/or internet address comprises one of a TCP port number, a UDP port number, a TP4 port number, an IP address or a CNLP address.

24. A computer program product according to claim 20, wherein the program code for selecting and the program code for transmitting are operative to execute on a Network Management System (NMS) node of a Cellular Digital Packet Data (CDPD) system.

25. A computer program product for configuring a wireless base station of a wireless mobile data communications system, the computer program product comprising program code embodiment in a computer-readable storage medium, the computer program code comprising:
program code for receiving a datagram including an assigned port number and/or internet address for the wireless base station; and
program code for configuring the wireless base station to accept datagrams addressed to the assigned port number and/or internet address in the received datagram.

26. A computer program product according to claim 25, wherein the wireless base station comprises a Mobile Data Base Station (MDBS) of a Cellular Digital Packet Data (CDPD) system.
